(19) United States
(12) Patent Application Publication
(10) Pub. No.: US 2022/0326665 A1
(43) Pub. Date: Oct. 13, 2022

(54) CONTROL SYSTEM, AND CONTROL METHOD

(71) Applicant: Hitachi, Ltd., Tokyo (JP)

(72) Inventors: Kohsei MATSUMOTO, Tokyo (JP); Yaemi TERAMOTO, Tokyo (JP)

(73) Assignee: Hitachi, Ltd., Tokyo (JP)

(21) Appl. No.: 17/639,811

(22) PCT Filed: Jan. 22, 2021
(86) PCT No.: PCT/JP2021/002279

§ 371 Date: Mar. 2, 2022

(30) Foreign Application Priority Data
Mar. 10, 2020 (JP) 2020-040746

(51) Int. Cl. G05B 13/02

(52) U.S. Cl. CPC G05B 13/0265

(57) ABSTRACT

This control system includes: a state calculating unit which calculates the state of a controlled object on the basis of control-system data including an actual measured value output from the controlled object and a predetermined target value; a reward granting unit which grants a reward in accordance with the state of the controlled object; an action selecting unit which selects an action for the state, on the basis of the granted reward; and a control parameter determining unit which, in. accordance with the selected action, determines a control parameter to lie used by a controller that calculates a command value to be input into the controlled object, on the basis of the actual measured. value, the target value, and a control rule.

### TECHNICAL FIELD

The present invention relates to a control system and a control method.

### BACKGROUND ART

As a method for promptly approximating a key performance indicator (KPI) of a process of a system such as a plant or an information technology (IT) to a target value, a method for optimizing feedback control by learning is disclosed (for example, Patent Document 1).

### CITATION LIST

### Patent Document

Patent Document 1: JP 2019-141869 A

### SUMMARY OF THE INVENTION

### Problems to be Solved by the Invention

In Patent Document 1, the feedback control is optimized by the learning, but the learning of the feedback control under the influence of the disturbance is not described. As an automatic adjustment method of a parameter for optimally controlling the feedback control, for example, the adjustment is automatically performed by software on the basis of a Ziegler-Nichols method. However, since the adjustment method is based on an empirical rule, optimality is low, and setting under the influence of the disturbance is complicated and difficult.

An object of one aspect of the present invention is to provide a control system and a control method in which a control parameter for controlling a controlled object can be suitably set or adjusted.

### Solutions to Problems

A control system according to one aspect of the present invention is configured as a control system including: a state calculating unit calculating a state of a controlled object on the basis of control-system data including an actual measured value output from the controlled object and a predetermined target value; a reward granting unit granting a reward in accordance with the state of the controlled object; an action selecting unit selecting an action for the state, on the basis of the granted reward; and a control parameter determining unit determining a control parameter to be used by a controller that calculates command value to be input into the controlled object, on the basis of the actual measured value, the target value, and a control rule, in accordance with the selected action.

### Effects of the Invention

According to one aspect of the present invention, it is possible to suitably set or adjust a control parameter for controlling a controlled object.

### BRIEF DESCRIPTION OF THE DRAWINGS

FIG. 1 is a diagram illustrating an example of a configuration of the entire system.

FIG. 2 is a diagram illustrating an example of a configuration of a machine learning subsystem.

FIG. 3 is a diagram illustrating an example of a hardware configuration of the system.

FIG. 4 is a diagram illustrating an example of processing of the machine learning subsystem.

FIG. 5 is a diagram illustrating an example of a conversion table.

FIG. 6 is a diagram illustrating an example of a response of a process (when there is no disturbance).

FIG. 7 is a diagram illustrating an example of a response of a process (when there is a disturbance).

### MODE FOR CARRYING OUT THE INVENTION

Hereinafter, an embodiment of the present invention will be explained with reference to the accompanying drawings. The following descriptions and drawings are exemplified for explaining the present invention, and are appropriately abbreviated and simplified for clarify the explanation. The present invention can be implemented in other various embodiments. The number of each component of the present invention may be singular or plural if not otherwise specified.

There are some cases where, in order to make the present invention more easily understood, the locations, sizes, shapes, ranges, and the like of respective components depicted in the drawings are differently from what those really are. Therefore, the present invention is not necessarily limited to the locations, sizes, shapes, ranges, and the like of the respective components disclosed in the drawings.

In the following descriptions, various types of information will be explained in the representations of “Table”, “List”, and the like in some cases, the various types of information may be represented in data structures other than “Table” and “List”. In order to show that the representations of the various types of information do not depend on specified data structures, “XX Table”, “XX List”, or the like is referred to as “XX Information” in some cases, for example. In the case of explaining identification information, although representations such as “Identification Information”, “Identifier”, “Name”, “ID”, and “Number” are used, these representations can be replaced with one another.

If there are plural components having the same functions or similar functions, the plural components are explained while the plural components are given the same reference signs having subscripts different from one another in some cases. However, if it is not necessary to distinguish these plural components from one another, the plural components are explained with the subscripts omitted.

In addition, in the following descriptions, there are some cases where pieces of processing performed by executing programs will be explained, and the programs are executed by a processor (for example, a CPU (Central Processing Unit), or a GPU (Graphics Processing Unit)) while predefined types of processing are performed by the processor using storage resources (for example, memories) and/or interface devices (for example, communication ports) appropriately, so that it can be interpreted that the main actor of the pieces of processing can be interpreted as the processor. Similarly, the main actor of processing performed by executing the programs may be a controller, an apparatus, a system, a computer, or a node as long as a processor is imbedded in each of these instruments. Furthermore, the main actor of processing performed by executing the programs may be a computing unit, and it is all right if the computing unit includes a dedicated circuit for performing specific processing (for example, an FPGA (Field-Programmable Gate Array) or an ASIC (Application Specific Integrated Circuit)). Each function may be partially or entirely remote insofar as the functions are linked by communication and processing is performed as a whole. In addition, the function may be selected as necessary.

The programs may be installed from a program source to an apparatus such as a computer. The program source may be, for example, a storage medium from which a program distribution server or a computer can read the programs. In the case of the program source being a program distribution server, it is all right if the program distribution server includes a processor and a storage resource storing programs to be distributed, and the processor in the program distribution server distributes the programs to be distributed to other computers. In addition, in the following descriptions, two or more programs may be materialized as one program, and one program may be materialized as two or more programs.

In addition, hereinafter, processing of each unit will be described through an example of controlling the number of times for displaying an advertisement on a website, but a target to which this system is applied is not necessarily limited to such processing. Here, as the website, a website is assumed in which an advertisement to be displayed is selected in accordance with an advertisement cost presented by a plurality of competing advertisers, that is, control for the own advertisement to be displayed on the website may not be directly performed. Here, it is understood that the number of times for display tends to increase as the advertisement cost increases. As described above, it is considered that control for decreasing a difference between a target value and an actual measured value of the number of times for displaying an advertisement by giving the advertisement cost to the website from a controller as input is performed, as the entire system. Hereinafter, as an example of a process, processing in an IT system including an website will be described, but the process may be applied to a motor or an engine, a pump, a heater, a vehicle or a ship, a robot, a manipulator, a working machine, a heavy machine, various home electrical appliances or facilities, and the like.

FIG. 1 illustrates the configuration of the entire system to be a controlled object. A controlled object system 1000 includes a process 101, a controller 102, a main system 103, and a machine learning subsystem 104.

First, the process 101 will be described. Here, the process indicates a controlled object. Here, the process corresponds to an actual website by the problem setting described above. The process 101 inputs a command value C and a disturbance-error X. Here, the command value corresponds to the advertisement cost by the problem setting described above. In addition, the disturbance-error corresponds to a variation in the number of times for displaying the own advertisement according to the bidding of the competing advertisers. In addition, the process 101 outputs a KPI actual measured value V2. Here, the KPI actual measured value corresponds to the actual number of times for displaying an advertisement on the website by the problem setting described above.

Next, the controller 102 will be described. Here, the controller indicates hardware such as a computer that has a control rule, gives the command value C to the process 101 on the basis of a given error E and a given control parameter P, and performs control. Here, the error indicates a difference between a KPI target value V1 and the KPI actual measured value V2. The KPI target value corresponds to the target value of the number of times for displaying an advertisement, and the KPI actual measured value corresponds to the actual measured value of the number of times for displaying an advertisement, by the problem setting described above. In addition, here, the control parameter indicates a parameter to be used in the control rule. Here, in a case where PID control is used in the control rule, P, I, and D are the control parameter.

The main system 103 is configured as a feedback control system including the controller 101 and the process 102 described above.

Next, the machine learning subsystem 104 will be described. Here, the machine learning subsystem indicates hardware such as a computer that learns the selection of the control parameter P to be used in the control rule of the controller 102 to be set in the controller 102 such that the controller 102 is capable of suitably controlling the process 101. Note that, it is assumed that the selection of the control parameter P is learned by using a simulator of the machine learning subsystem 104, and is further learned by using information from the main system 103 on the basis thereof. Before performing the learning in the main system 103, the learning is performed by using the simulator, and thus, a possibility that unexpected behavior that may occur during the learning occurs in the main system 103 is reduced, and the learning is speeded up by using the simulator that responds faster than the main system 103.

As described above, in the entire system, first, the machine learning subsystem 104 performs the learning of the selection of the control parameter using the simulator of the website. Next, the control parameter P is calculated from the KPI target value V1 and the KPI actual measured value V2 of the number of times for displaying an advertisement, the disturbance-error X, and the command value C, which are input into the machine learning subsystem 104 from the main system 103, and sets the control parameter P in the controller 102. Subsequently, the command value C is output in accordance with the control parameter P and the control rule set in the controller 102, the process 101 is controlled on the basis of the command value C, and the KPI actual measured value V2 of the number of times for displaying an advertisement on the website is fed back, and thus, the entire control is performed. Note that, the machine learning subsystem 104 sequentially performs additional learning while using a result of the learning with the simulator as an initial value, on the basis of the information to be input into the machine learning subsystem 104 from the main system 103.

Note that, in a case where it is determined that a difference between a disturbance assumed by the simulator and a disturbance that occurs in actual operation, or a difference between the behavior of the simulated process (here, the website) and the behavior of the actual process (here, the website) is small, the control parameter obtained by the learning with the simulator without the additional learning may be used in operation (without the additional learning). Further, in this example, the learning is performed on the basis of data obtained by a simulation in a state where the disturbance is not added, a result thereof is used as the initial value, and the additional learning is performed in operation accompanied by the disturbance, but a result of performing the learning on the basis of data obtained by a simulation in a state where the disturbance is added may be used as the initial value, and control may be performed such that the additional learning is performed in operation accompanied by the disturbance or the additional learning is not performed in operation.

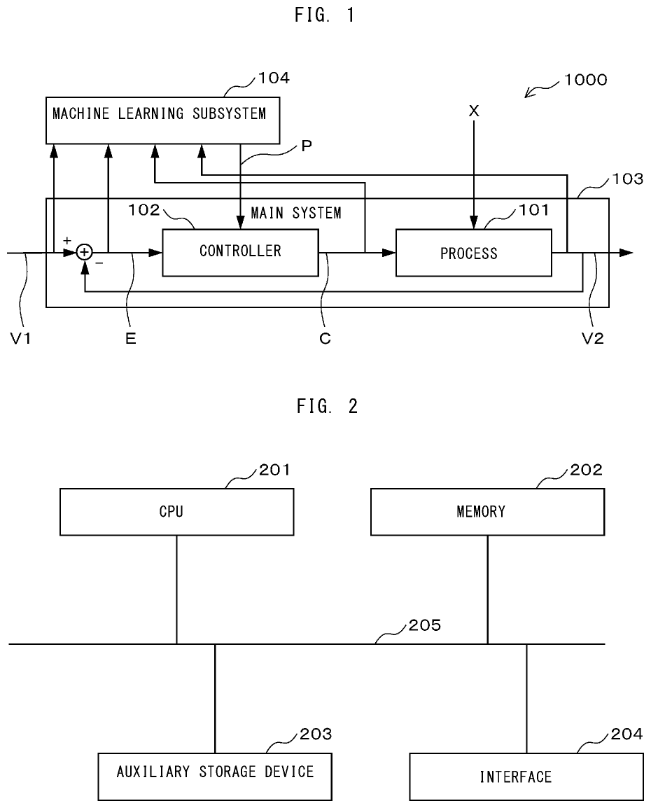

The process 101 and the controller 102 configuring the main system 103, and the machine learning subsystem 104 are capable of using a general computer as the hardware. FIG. 2 is a diagram illustrating a hardware configuration example of the general computer. As illustrated in FIG. 2, as the computer, a CPU 201 that executes various processing items by controlling the computer, a memory 202 that stores a program for executing various processing items, an auxiliary storage device 203 that stores data obtained by executing the program, and an interface 204 that is an input/output interface receiving a manipulation from a user or a communication interface communicating with the other computer are connected to each other through a bus 205.

The functions of the process 101 and the controller 102, and the machine learning subsystem 104, for example, are attained by the CPU 201 executing the processing by reading out the program from a read only memory (ROM) configuring the memory 202, and by performing read and write with respect to a random access memory (RAM) configuring the memory 202. The program may be provided by being read out from a storage medium such as a universal serial bus (USB) memory, or by being downloaded from the other computer through a network.

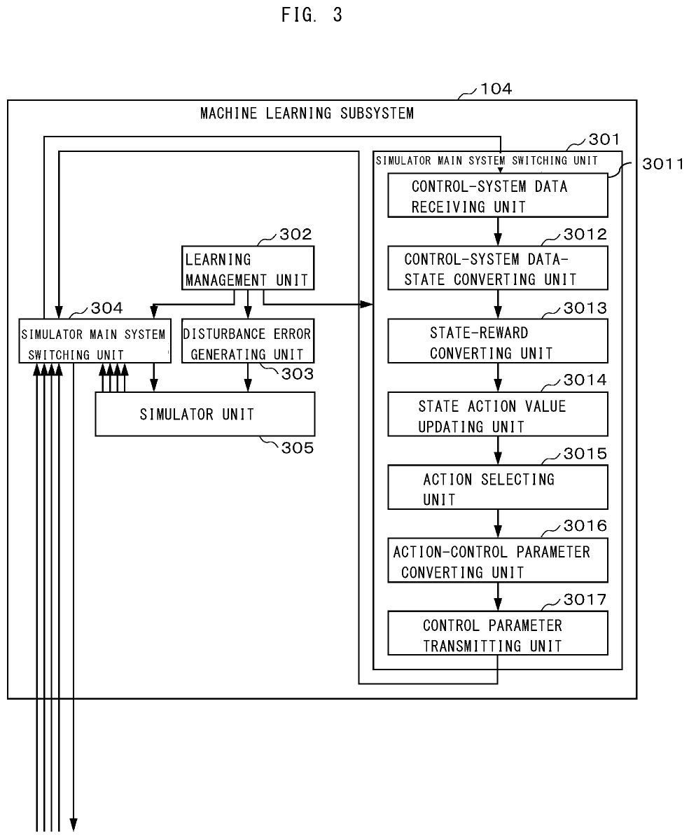

In the system as described above, a configuration example of the machine learning subsystem 104 is illustrated in FIG. 3. The machine learning subsystem 104 includes a learning-action selecting unit 301, a learning management unit 302, a disturbance-error generating unit (setting unit) 303, a simulator-main system switching unit 304, and a simulator unit 305. In addition, the learning-action selecting unit 301 includes a control-system data receiving unit 3011, a control-system data-state converting unit (state calculating unit) 3012, a state-reward converting unit (reward granting unit) 3013, a state-action value updating unit (reward updating unit) 3014, an action selecting unit 3015, an action-control parameter converting unit (control parameter determining unit) 3016, and a control parameter transmitting unit 3017.

Note that, hereinafter, each functional unit of the machine learning subsystem 104 is provided in the computer that is the general computer, as the hardware, but the same function may be attained by distributing a part or all of the functional units to one or a plurality of computers such as a cloud to communicate with each other.

The simulator unit 305 indicates a program for simulating the input/output of the main system 103. Here, in particular, the simulator unit 305 indicates a program for outputting the KPI actual measured value (hereinafter, a virtual actual measured value) that is the number of times for displaying an advertisement to be obtained in the simulation when the control parameter P or the KPI target value that is the number of times for displaying an advertisement to be a target is input into the controller 102. Note that, the disturbance or the error that is set by an external computer or an external system (for example, a server connected to the machine learning subsystem 104 through a network) can be set in the simulator unit 305. For example, a case is assumed in which the competing advertisers set a high advertisement cost, and even when a predetermined advertisement cost is set on the machine learning subsystem 104 side, the virtual actual measured value of the number of times for displaying an advertisement is not uniquely set but a value to which the error generated by the disturbance-error generating unit 303 is added. Note that, the disturbance-error generating unit 303 is capable of generating a value according to a probability distribution set by using various statistical methods, or setting a value relevant to a bias that is empirically known as the disturbance or the error.

As described above, the simulation unit (for example, the simulator unit 305) performs a simulation that inputs the control parameter determined by the control parameter determining unit and the KPI target value into the controller 102, and outputs the KPI actual measured value.

When performing the processing in the learning-action selecting unit 302, the simulator-main system switching unit 304 indicates a program for switching a case of connecting the learning-action selecting unit 302 and the simulator unit 305 and a case of connecting the learning-action selecting unit 301 and the main system 103.

The learning management unit 302 indicates a program for performing the control of the learning in the learning-action selecting unit 301, the setting when performing the learning by using the disturbance-error simulator unit 305, and the control of the simulator-main system switching unit 304 in accordance with a learning situation or the like.

Here, the learning-action selecting unit 301 performs suitable learning for selecting a control parameter on the basis of a framework of reinforcement learning, and the information (hereinafter, control-system data) to be obtained from the simulator unit 305 or the main system 103.

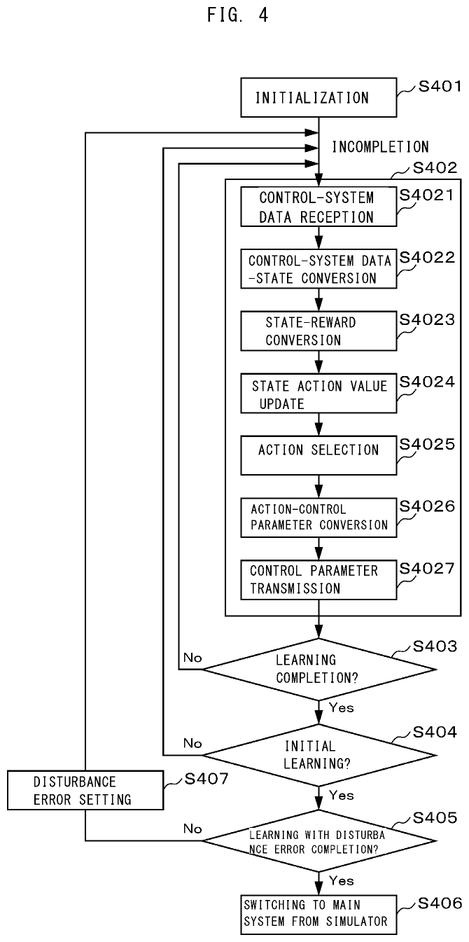

Hereinafter, a processing flow of the machine learning subsystem 104 in FIG. 3 will be described while using FIG. 4. As described below, in the machine learning subsystem 104, the KPI target value, the input to the process, and the KPI actual measured value to be obtained from the process are set as a state, and an evaluated value (reward) according to the size of the error is calculated from the history of the state. Then, an action (a control parameter such as PID) to be taken in accordance with each state is subjected to machine learning (reinforcement learning) on the basis of the evaluated value.

In a case where the processing in the machine learning subsystem 104 starts, each determination flag, the state of the simulator, or the like is set to the initial value by initialization processing in the learning management unit 302 (S401).

Next, initial learning is performed in the main processing that is performed by the learning-action selecting unit 301 (S402). The initial learning indicates learning in a situation in which the disturbance-error is not set in the simulator unit 305.

here, first, reception processing of the control-system data is performed by the control-system data receiving unit 3011 of the learning-action selecting unit 301 (S4021). Accordingly, the KPI target value that is the target value of the number of times for displaying an advertisement and the virtual actual measured value that is the KPI actual measured value of the number of times for displaying an advertisement, the error, and the command value are acquired from the simulator unit 305, as the control-system data. Note that, in a case where switching to the main system 103 is performed the simulator-main system switching unit 304, the control-system data is acquired from the main system 103.

Next, control-system data-state conversion processing is performed by the control-system data-state converting unit 3012 (S4022). Here, the control-system data-state conversion processing indicates processing of calculating and converting to a state to be obtained by discretizing the control-system data that is not subjected to statistical processing or the like or a state to be obtained by obtaining a change amount from the control-system data that is not subjected to the statistical processing or the like, for example, the error, and then, by discretizing the change amount.

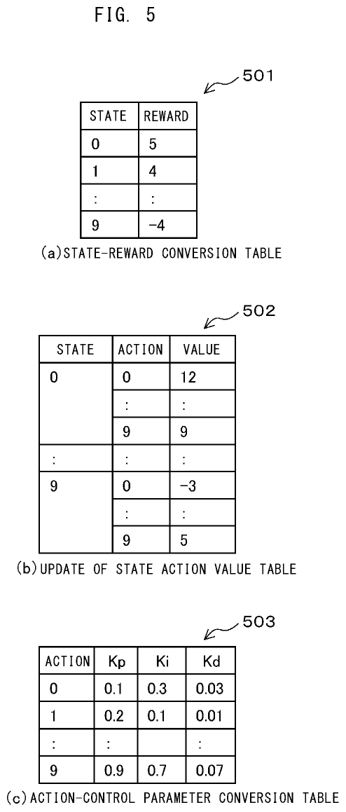

Next, state-reward conversion processing is performed by the state-reward converting unit 3013 (S4023). For example, the state-reward converting unit 3013 grants a large value as a reward as the error decreases, in states to be obtained by the discretization of a difference (error) between the KPI target value that is the target value of the number of times for displaying an advertisement and the virtual actual measured value that is the KPI actual measured value of the number of times for displaying an advertisement, by the problem setting described above (FIG. 5(a)). For example, in a case where the KPI actual measured value is greater than the KPI target value, a negative reward is granted, and in a case where the KPI target value is less than or equal to the KPI actual measured value, a large positive reward is granted as a difference between the KPI target value and the KPI actual measured value decreases. FIG. 5(a) illustrates an example of a state-reward conversion table 501 in which the state to be obtained by the discretization is associated with the reward for the state. As described above, the state-reward converting unit 3013 stores the state-reward conversion table 501 in a memory of the machine learning subsystem 104.

Note that, the state-reward converting unit 3013 may grant not only the error, for example, but also an inverse number of time required for convergence as the reward. In addition, a reward in which the rewards described above are combined may be granted. In addition, in a case where there are a plurality of rewards with different standards, the state-reward converting unit 3013 may grant the weighted sum of the rewards in accordance with the state.

Next, state-action value update processing is performed by the state-action value updating unit 3014 (S4024). The state-action value update processing corresponds to the update of a state-action value in the framework of the reinforcement learning. First, here, the action indicates the selection of the combination of the control parameters, and the update of the state-action value indicates the calculation of a value for selecting an action in the previous state on the basis of the reward obtained as a result of the action selected in the previous state, on the basis of the obtained reward, by the problem setting described above. Note that, here, for simplicity, the previous state and the value of the action selected in the previous state are focused, but a state before the previous state may be focused.

In a case where Q learning is applied as a reinforcement learning method, the update of the state-action value corresponds to update processing of a Q value. For example, as with a state-action value table 502 illustrated in FIG. 5(b), a certain reward is obtained as a result of actually selecting an action by assuming that there are a plurality of actions that can be taken for each discretized state. The state-action value updating unit 3014 updates the reward by adding the reward to the value of the action (in a case of applying the Q learning, the Q value) (in a case of applying the Q learning, the update is performed in accordance with an update expression of the Q value). FIG. 5(b) illustrates that the discretized state, the action that can be taken in the state, and the value when selecting the action are stored in association with each other. The action that can be taken in the state is obtained as a result of selecting the combination of the control parameters, and for example, as described below, a value to be obtained by a combination of control parameters Kp, Ki, and Kd. In addition, the value when selecting the action is the total reward to be calculated by adding the reward corresponding to each state when selecting the action, and the value is updated by the state-action value updating unit 3014.

As described above, the reward updating unit (for example, the state-action value updating unit 3014) calculates a value for selecting an action in a certain state, on the basis of a reward obtained in accordance with the action selected by the action selecting unit in the certain state, and the action selecting unit selects the action for the state, on the basis of the value updated by the reward updating unit (for example, the value illustrated in FIG. 5(b)). Next, action selection processing is performed by the action selecting unit 3015 (S4025). The action selection processing indicates processing of selecting an action with a high value at a high probability, in the actions that can be taken in the certain. As illustrated in FIG. 5(c), here, the action is the combination of the control parameters Kp, Ki, and Kd, and an association between the action and the combination of the control parameters is set in advance as an action-control parameter conversion table 503. FIG. 5(c) illustrates that the action that can be taken in the certain state and the value of the control parameter for the action are stored in association with each other.

Next, action-control parameter conversion processing is performed by the action-control parameter converting unit 3016 (S4026). Here, the combination of the control parameters corresponding to the selected action is determined by using the action-control parameter conversion table 503 described above.

Next, control parameter transmission processing is performed by the control parameter transmitting unit 3017 (S4027). Accordingly, the control parameter is set in the simulator unit 305. Note that, in a case where the switching to the main system 103 is performed by the simulator-main system switching unit 304, the control parameter is set in the main system 103.

Processing in which the learning-action selecting unit 301 and the simulator unit 305 are linked, the control-system data is received from the simulator, the control parameter is transmitted to the simulator, and the simulation is executed is set as one step, and the machine learning subsystem 104 performs a plurality of designated steps of the processing. The plurality of steps are set as one episode, and the machine learning subsystem 104 performs a plurality of designated episodes of the processing.

The execution of the processing in the step unit and the episode unit is controlled, and learning managing determination processing is performed by the learning management unit 302 (S403). In the learning managing determination processing, the learning management unit 302 determines whether or not the processing reaches a predetermined number of episodes or a change rate of the sum of the rewards for each episode is less than a threshold value, and in a case where it is determined that the result corresponds to such a condition (S403; Yes), the learning management unit 302 determines that the learning is completed. On the other hand, in a case where it is determined that the result does not correspond to such a condition (S403; No), the learning management unit 302 determines that the learning is not completed. Note that, in a case where the learning is not completed, the processing of the learning-action selecting unit 301 is executed again.

In a case where the learning is completed, the learning management unit 302 determines whether or not it is the first learning by initial learning determination processing (S404). In a case where the learning management unit 302 determines that the first learning is not completed (S404; No), the processing o the learning-action selecting unit 301 is executed again.

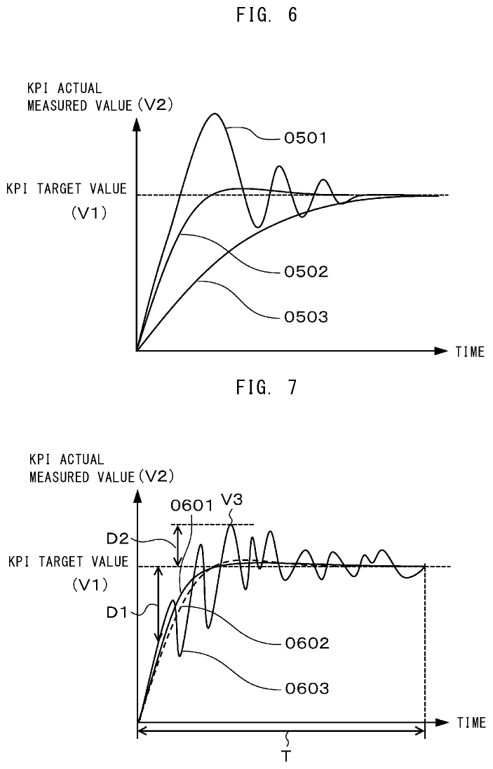

Here, a change in the response of the process during the learning in the initial learning is illustrated in FIG. 6. Here, the process is the website, and the KPI actual measured value (V2) thereof is the actual measured value of the number of times for displaying an advertisement. Here, in the initial learning, the KPI actual measured value corresponds to the virtual actual measured value for performing the learning by using the simulator unit 305. In addition, it is assumed that the response of the website, here, can be expressed by a temporary delay system. In the drawing, a graph 0501 and a graph 0503 indicate that it is in the middle of the learning. In each of the graphs, the KPI actual measured value reaches the KPI target value (V1) with time, but the KPI actual measured value greatly overshoots until the KPI actual measured value reaches the KPI target value, or it takes a long time to reach the KPI target value. In contrast, the learning management unit 302 learns a method for determining the control parameter (for example, the selection of the control parameter illustrated in FIG. 5(c)), and thus, as illustrated in a graph 0502, the overshoot decreases, that is, the error decreases, and the KPI actual measured value is capable of rapidly converging to the KPI target value. Accordingly, the learning management unit 302 learns the method for determining the control parameter by the control parameter determining unit such that the reward increases.

In S404, in a case where it is determined that the first learning is completed (S404; Yes), the learning management unit 302 performs learning completion determination processing with a disturbance-error (S405). In a case where the first learning is completed, but the disturbance-error is not learned in the first learning, in the learning completion determination processing with a disturbance-error, it is determined that learning considering the disturbance-error is not completed (S405; No), and disturbance-error setting processing is performed by the disturbance-error generating unit 303 (S407). Accordingly, the error is added to the virtual actual measured value. In such a situation, as with the initial learning, the processing of the learning-action selecting unit 301 is performed on the basis of a learning result obtained by the initial learning. Accordingly, learning in a situation where the disturbance is added is performed on the basis of the learning result obtained by the initial learning. Accordingly, a learning result that is more suitable for the disturbance is obtained.

Accordingly, the setting unit (for example, the disturbance-error generating unit 303) sets the disturbance or/and the error with respect to the controlled object (for example, process 101), and the simulation unit performs the simulation that outputs the controlled object in a state where the disturbance or/and the error is not set by the setting unit, and performs the additional simulation that outputs the controlled object in a state where the disturbance or/and the error is input, and the following processing is performed.

Note that, the simulation unit may perform the following simulation. For example, the simulation unit executes the processing of S407 in the initial learning, performs the simulation in a state where the disturbance or/and the error is set by the setting unit, and performs the learning on the basis of the data to be obtained. Then, the result thereof may be used as the initial value, and for example, the additional learning based on the data to be obtained by the additional simulation may be further executed in operation accompanied by the disturbance, and then, the switching to the main system 103 may be performed. Alternatively, in operation after the initial learning in which the processing of S407 is executed, the switching to the main system 103 may be performed without executing the additional learning. Further, the simulation unit may perform the simulation or the additional simulation in a state where a disturbance or/and an error greater than or equal to the disturbance or/and the error to be assumed in operation are added by the setting unit. According to such control, the simulation in a state where the disturbances or/and the errors of various values are set can be performed.

The machine learning subsystem 104 performs the learning with the disturbance described above, and determines whether or not a predetermined condition is satisfied, for example, whether or not the average error or the time to convergence is less than a threshold value, in the learning completion determination processing with a disturbance-error of S405. In a case where it is determined that such a predetermined condition is satisfied (S405; Yes), the learning management unit 302 determines that the learning is completed, and in a case where it is determined that the predetermined condition is not satisfied, the predetermined condition as described above is not satisfied, and thus, the learning management unit 302 determines that the learning is not completed (S405; No). Note that, in a case where it is determined that the learning is not completed, the processing of the learning-action selecting unit 301 is executed again while changing the disturbance-error in S407.

Here, a change in the response of the process during the learning in a state where the disturbance is added is illustrated in FIG. 7. In the drawing, a graph 0602 indicates a response according to the initial learning. In a case where the disturbance is added to the response, for example, a response as with a graph 0603 is obtained. A learning result obtained by the initial learning, that is, a method for selecting the control parameter is used as the initial value, and the learning under the influence of the disturbance as with the graph 0603 is performed, and thus, as with a graph 0601, a response in which the influence of the disturbance is suppressed can be obtained.

In S405, in a case where it is determined that the learning considering the disturbance-error is completed (S405; Yes), switching processing to the main system from the simulator is performed by the simulator-main system switching unit 304 (S406).

In a case where S406 is performed, and subsequently, learning processing using the main system 103 is performed. Since the learning processing itself is the same processing except that the control-system data to be used in the learning is acquired from the main system 103 but not the simulator, the control parameter is set in the controller 102 of the main system 103 but not the simulator, and additional learning processing is performed on the basis of a learning result using the simulator, here, the description thereof will be omitted.

Note that, FIG. 7 illustrates a case in which the disturbance-error (for example, an error D1 between the KPI actual measured value V2 and the KPI target value V1) is considered as an example of a change in the response of the process during the learning in a situation where the disturbance is added. In addition, for example, the reward may be calculated in accordance with a difference D2 between a maximum value V3 of the KPI actual measured value V2 and the KPI target value V1 in the graph 0603, or the reward may be calculated in accordance with the length of a time T until the KPI actual measured value V2 converges to the KPI target value V1. Accordingly, various differential information items to be obtained from a difference between the KPI actual measured value and the KPI target value, such as an error between the KPI actual measured value and the KPI target value, a difference between a value at which the KPI actual measured value satisfies a predetermined condition (for example, the maximum value) and the KPI target value, and the length of the time until the KPI actual measured value converges to the KPI target value, may be input, the state calculating unit may calculate the state of the controlled object, and then, the reward may be calculated. It is obvious that the learning in a situation where the disturbance is not added, illustrated in FIG. 6, can be considered in the same manner.

As described above, according to the machine learning subsystem 104 of this example, since the state calculating unit (for example, the control-system data-state converting unit 3012) calculating the state of the controlled object on the basis of the control-system data including the actual measured value (for example, the KPI actual measured value) output from the controlled object (for example, the process 101) and the predetermined target value (for example, the KPI target value), the reward granting unit (for example, the state-reward converting unit 3013) granting the reward in accordance with the state of the controlled object, the action selecting unit (for example, the action selecting unit 3015) selecting the action for the state, on the basis of the granted reward, and the control parameter determining unit (for example, the action-control parameter converting unit 3016) determining the control parameter to be used by the controller 102 that calculates the command value to be input into the controlled object on the basis of the actual measured value, the target value, and the control rule (for example, the PID control), in accordance with the selected action, are provided, the control parameter for controlling the controlled object can be suitably set or adjusted. In addition, since the state calculating unit further calculates the state on the basis of the control-system data including the differential information (for example, the error between the KPI target value and the KPI actual measured value, the difference between the value at which the KPI actual measured value satisfies the predetermined condition (for example, the maximum value) and the KPI target value, and the length of time until the KPI actual measured value converges to the KPI target value) obtained from the difference between the actual measured value and the target value, and the command value, and the control parameter determining unit determines the control parameter on the basis of the actual measured value, the target value, the differential information, and the control rule, for example, it is possible to attain a reduction in the effort of manual adjustment, and a reduction in a difference (error) between the output of the controlled object and the target value and rapid convergence, by dynamically automatically adjusting the control parameter of the controller in accordance with error. In addition, the controller promptly minimizing a difference (error) between the output of the process and the target value can be attained even under the influence of the disturbance.

### REFERENCE SIGNS LIST

1000 Controlled object system
101 Process
102 Controller
103 Main system
104 Machine learning subsystem
301 Learning-action selecting unit
302 Learning management unit
303 Disturbance-error generating unit
304 Simulator-main system switching unit
305 Simulator unit
3011 Control-system data receiving unit
3012 Control-system data-state converting unit
3013 State-reward converting unit
3014 State-action value updating unit
3015 Action selecting unit
3016 Action-control parameter converting unit
3017 Control parameter transmitting unit

1. A control system, comprising:
a state calculating unit calculating a state of a controlled object on the basis of control-system data including an actual measured value output from the controlled object and a predetermined target value;
a reward granting unit granting a reward in accordance with the state of the controlled object;
an action selecting unit selecting an action for the state, on the basis of the granted reward; and
a control parameter determining unit determining a control parameter to be used by a controller that calculates a command value to be input into the controlled object, on the basis of the actual measured value, the target value, and a control rule, in accordance with the selected action.

2. The control system according to claim 1,
wherein the state calculating unit further calculates the state on the basis of the control-system data including differential information obtained from a difference between the actual measured value and the target value, and the command value, and
the control parameter determining unit determines the control parameter on the basis of the actual measured value, the target value, the differential information, and the control rule.

3. The control system according to claim 1, further comprising:
a reward updating unit calculating a value for selecting an action in a certain state, on the basis of a reward obtained in accordance with the action selected in the certain state by the action selecting unit,
wherein the action selecting unit selects the action for the state, on the basis of the value updated by the reward updating unit.

4. The control system according to claim 1, further comprising:
a simulation unit performing a simulation that inputs the determined control parameter and the target value into the controller and outputs the actual measured value.

5. The control system according to claim 4, further comprising:
a setting unit setting a disturbance or/and an error with respect to the controlled object,
wherein the simulation unit performs a simulation of output of the controlled object in a state in which the disturbance or/and the error are not set by the setting unit, and performs an additional simulation of output of the controlled object in a state in which the disturbance or/and the error are input by the setting unit.

6. The control system according to claim 5,
wherein the simulation unit performs the simulation in a state in which the disturbance or/and the error are set by the setting unit.

7. The control system according to claim 5,
wherein the simulation unit performs the simulation or the additional simulation in a state in which a disturbance or/and an error greater than the disturbance or/and the error to be assumed in operation are added by the setting unit.

8. The control system according to claim 1,
wherein the reward granting unit grants a negative reward when the actual measured value is greater than the target value, and grants a large positive reward as a difference between the target value and the actual measured value decreases when the target value is less than or equal to the actual measured value.

9. The control system according to claim 1, further comprising:
a learning management unit learning a method for determining the control parameter by the control parameter determining unit such that the reward increases.

10. The control system according to claim 2,
wherein the state calculating unit calculates the state of the controlled object by inputting an error between the actual measured value and the target value as the differential information.

11. The control system according to claim 2,
wherein the state calculating unit calculates the state of the controlled object by inputting a difference between a value at which the actual measured value satisfies a predetermined condition and the target value as the differential information.

12. The control system according to claim 2,
wherein the state calculating unit calculates the state of the controlled object by inputting a length of time until the actual measured value converges to the target value as the differential information.

13. A control method, comprising:
allowing a state calculating unit to calculate a state of a controlled object on the basis of control-system data including an actual measured value output from the controlled object and a predetermined target value;
allowing a reward granting unit to grant a reward in accordance with the state of the controlled object;
allowing an action selecting unit to select an action for the state, on the basis of the granted reward; and
allowing a control parameter determining unit to determine a control parameter to be used by a controller that calculates a command value to be input into the controlled object, on the basis of the actual measured value, the target value, and a control rule, in accordance with the selected action.
